(19) United States
(12) Patent Application Publication
(10) Pub. No.: US 2012/0128910 A1
(43) Pub. Date: May 24, 2012

(54) SILANE GRAFTED POLYETHYLENE WITH A REDUCED LEVEL OF EXTRACTABLE METHANOL

(75) Inventor: Carl M. Mahabir, Streetsboro, OH (US)

(73) Assignee: Lubrizol Advanced Materials, Inc., Cleveland, OH (US)

(21) Appl. No.: 13/115,538

(22) Filed: May 25, 2011

Related U.S. Application Data
(60) Provisional application No. 61/347,870, filed on May 25, 2010.

(51) Int. Cl. C08K 3/34; B32B 1/08; B29C 47/00

(52) U.S. Cl. 428/36.9; 523/103; 264/209.6

(57) ABSTRACT

A hydrophobic molecular sieve having a pore size of about 5 Å can be blended into a silane grafted crosslinkable polyethylene to reduce the level of extractable methanol present in articles made with such polymeric compositions after crosslinking. The molecular sieve apparently acts to “lock-up” the methanol generated as a by-product of the crosslinking reaction without compromising the desirable chemical or physical properties of articles that are manufactured with the crosslinked polyethylene.

### RELATED APPLICATION

This application claims the benefit of U.S. Provisional Application No. 61/347,870, filed on May 25, 2010. The entire teachings of the above application are incorporated herein by reference.

### FIELD OF THE INVENTION

This invention relates to crosslinkable polyethylene composition that can be utilized in manufacturing various articles of manufacture. This crosslinkable polyethylene composition is of particular value for utilization in manufacturing crosslinked polyethylene pipe for the distribution of potable water since a reduced level of extractable methanol is present in cases where it is employed in making such pipe.

### BACKGROUND OF THE INVENTION

Various articles of manufacture are made utilizing polyethylene which is crosslinked after being molded or extruded during the manufacturing process. For instance, the “sioplas” process and the “monosil” process are widely used in manufacturing articles which are comprised of crosslinked polyethylene, such as polyethylene pipe. However, one significant drawback associated with the sioplas process and monosil process is that methanol is generated as a by-product of the crosslinking reaction. This is of particular concern in cases where the article manufactured is intended for use in applications where it comes in contact with potable water. For instance, residual methanol in a crosslinked polyethylene pipe can migrate into water flowing through the pipe and can result in an unacceptable level of contamination.

Crosslinked polyethylene (PEX) offers an excellent array of physical characteristics, cost advantages, and long service life that make it highly desirable for utilization in water pipes. In particular, crosslinking of polyethylene has been shown to increase maximum useful service temperature, reduce creep, improve chemical resistance, increase abrasion resistance, improve memory characteristics, improve impact resistance, and improve environmental stress cracking resistance as compared to uncrosslinked polyethylene. However, the problem associated with residual methanol migration into the water conveyed through such PEX pipes continues to be of concern. U.S. Pat. No. 6,284,178 appreciates this problem associated with high levels of residual methanol and notes that methanol levels can be reduced by increasing the curing time employed in manufacturing the PEX article. The techniques revealed in U.S. Pat. No. 6,284,178 are reported to be useful in making PEX having a low enough methanol extraction value (using the ANSI/NSF 61 standard) to qualify for use in potable water systems. Even though this approach is technically viable it is not universally acceptable from a commercial standpoint since its implementation would lead to reduced manufacturing throughput and increased manufacturing cost.

One other possible approach to the problem of contamination with residual methanol would be to replace the vinyl trimethoxysilane which is normally used in the sioplas process and the monosil process with vinyl triethoxysilane. Such a substitution of vinyl triethoxysilane into the process in place of vinyl trimethoxysilane would result in the formation of ethanol rather than methanol. This would be greatly advantageous since ethanol (ethyl alcohol) is not toxic at low levels and its metabolism by humans and animals is well understood. However, vinyl triethoxysilane cannot simply be substituted into the sioplas process or the monosil process in place of vinyl methoxysilane because it participates in the crosslinking step of the process at a commercially unacceptable rate.

Many techniques for producing articles of manufacture that are comprised of crosslinked polyethylene are known in the art. For instance, U.S. Pat. No. 4,117,195 discloses a method for producing PEX pipe using silane grafted PEX. In this process the polyethylene is metered into a screw extrusion machine together with compounding ingredients comprising a hydrolysable unsaturated silane, a free-radical generator and a silanol condensation catalyst. The compounding ingredients are blended with the polymer in the barrel of the extruder and the mixture is heated sufficiently to effect grafting of silane groups to the polymer, the amount of free-radical generator being sufficiently low to limit direct free-radical crosslinking to a level that will not prevent extrusion of the material. The reaction mixture is extruded directly from the same extruder through an extrusion die to form an elongate shaped product and crosslinking is effected by subjecting the shaped product to the action of moisture.

U.S. Pat. No. 5,756,023 reveals a method of producing reformed crosslinked polyethylene articles wherein the reformed crosslinked articles are free of visible and objectionable folds, seams, and interfaces on reformed surfaces thereof. A preferred embodiment of the method described in U.S. Pat. No. 5,656,023 includes the steps of extruding a silane-grafted polyethylene tube, heating an end of the tube, reforming the end of the tube to produce a radially enlarged sealing surface thereon, cooling the reformed tube, and curing the reformed tube to produce an increase in the degree of crosslinking of the polyethylene material.

U.S. Pat. No. 7,086,421 discloses a multilayer crosslinked polyethylene (“PEX”) pipe comprising: (a) an inner tubular core of high density polyethylene (“HDPE”) having a maximum wall thickness from about 28 to 100 times smaller than the nominal diameter of pipe in the range from 7 mm (0.25″) to 152 mm (6″), ratio 28 being attributable to small diameter non-SDR-9 piping, and ratio 100 being attributable to the larger diameter SDR-9 pipe, wherein the HDPE has a density in the range from 0.941 g/cc to 0.963 g/cc; and, (b) an outer tubular sheath of at least one layer of a crosslinked polyethylene contiguous with the outer surface of the inner core layer, wherein said PEX is crosslinked to a gel level of at least 65% by a silane grafting process.

U.S. Pat. No. 7,255,134 discloses pipe or tubing of crosslinked polyethylene (PEX) that includes carbon black at a level of less than 2% to improve resistance to oxidizing agents, such as chlorine and hypochlorous acid in water. This patent more specifically reveals a pipe of crosslinked polyethylene having a wall of substantially uniform thickness in the range from 1.78 mm to 17.29 mm having dispersed therein from 0.1 to about 1.25% by weight of carbon black having a particle size less than 27 nm (nanometers), and wherein said PEX is crosslinked by a method selected from the addition of AZO compounds and silane grafting process said pipe including, an inner tubular core of protective polymer selected from the group consisting of high density polyethylene (HDPE) and chlorinated polyethylene (CPE) contiguous with the inner surface of the crosslinked PEX, the core having a substantially uniform wall thickness in the range from 0.025 mm (1 mil) to 1.52 mm (0.06″), and a maximum wall thickness in the range from about 28 to 100 times smaller than the nominal diameter of the pipe in the range from 7 mm (0.25″) to 152 mm (6″), ratio 28 being attributable to small diameter non-SDR-9 piping, and ratio 100 being attributable to the larger diameter SDR-9 pipe, wherein the HDPE has a density in the range from 0.941 g/cc to 0.963 g/cc, and the chlorinated polyethylene has a chlorine content in the range from 5 to about 50% by weight.

United States Patent Publication No. 2007/0184227 A1 discloses silane crosslinked polyolefin tubes having a minimum crosslinking degree of 60% that are intended for drinking water and/or water for industrial use and which are resistant to a chlorine content between 0.1 and 5 ppm. These polyolefin tubes are manufactured by a single-stage process which is characterized by the polyolefin composition comprises (A) a polyolefin, (B) a mixture of an organic silane of the general formula RSiX₃ with a radical-generating constituent and a catalyst (B3), and with a stabilizer mixture of a high melting point, high-molecular phenolic constituent with a sulfur-containing constituent, a phosphorus-containing processing stabilizer and a metal deactivator.

### SUMMARY OF THE INVENTION

The problem associated with residual methanol being in products made with crosslinked polyethylene continues to be of concern today. This problem is of particular relevance in cases where the product made with the crosslinked polyethylene comes in contact with potable water. For instance, it is important for crosslinked polyethylene pipes utilized in the conveyance of potable water to contain no more than a very low level of residual methanol. More specifically, a maximum level of 20 ppm of extractable methanol is frequently demanded today. However, for technical, commercial, and economic reasons a good solution to this problem has been elusive. There is accordingly a long felt need for a commercially viable low cost technique for producing crosslinked polyethylene articles, such as crosslinked polyethylene water pipes and tubes.

This invention is based upon the unexpected finding that a hydrophobic molecular sieve having a pore size of about 5 Å can be blended into a silane grafted crosslinkable polyethylene to reduce the level of extractable methanol present in articles made with such polymeric compositions after crosslinking. The molecular sieve apparently acts to “lock-up” the methanol generated as a by-product of the crosslinking reaction without compromising the desirable chemical or physical properties of articles that are manufactured with the crosslinked polyethylene. In other words, articles of manufacture made utilizing the graft polyethylene and technique of this invention offer all of the chemical and physical characteristics of products made utilizing conventional technology while offering a lover level of extractable methanol. This is because the crosslinked polyethylene made by the method of this invention is essentially identical to the polymer that results by practicing conventional technology except, of course, in that it offers the advantage of offering lower level of extractable methanol.

The present invention more specifically discloses a crosslinkable polyethylene graft polymer composition which is comprised of polyethylene and a hydrophobic molecular sieve, wherein the polyethylene has vinyl trialkoxysilane units grafted thereon, and wherein the molecular sieve has a pore diameter which is within the range of 4.0 Å to about 6.0 Å, and wherein the molecular sieve has an average particle size of less than about 15 μm.

The subject invention further reveals a process for manufacturing polyethylene pipe which comprises (1) extruding a crosslinkable polyethylene graft polymer composition into a the form of an uncured pipe, wherein the crosslinkable polyethylene graft polymer composition is comprised of polyethylene and a hydrophobic molecular sieve, wherein the polyethylene has vinyl trialkoxysilane units grafted thereon, and wherein the molecular sieve has a pore diameter which is within the range of 4.0 Å to about 6.0 Å, and wherein the molecular sieve has an average particle size of less than about 15 μm, (2) curing uncured pipe at an elevated temperature of at least about 150° F. (66° C.) in the presence of moisture to produce a cured pipe, and (3) allowing the cured pipe to cool to ambient temperature to produce the crosslinked polyethylene pipe.

The present invention also discloses a crosslinked polyethylene pipe wherein the body of the pipe is comprised of a crosslinked polyethylene graft polymer which includes a hydrophobic molecular sieve having a pore diameter which is within the range of 4.0 Å to about 6.0 Å, and wherein the hydrophobic molecular sieve has an average particle size of less than about 15 μm. It is normally beneficial for the molecular sieve to be a hydrophobic molecular sieve.

### DETAILED DESCRIPTION OF THE INVENTION

The crosslinkable polyethylene graft polymer compositions of this invention are made by simply dispersing a molecular sieve having a pore size which is within the range of 4.0 Å to about 6.0 Å into a silane grafted crosslinkable polyethylene resin. The polyethylene used will typically be high density polyethylene homopolymer (HDPE). It should be noted that polyethylene is generally regarded as being high density polyethylene if it has a density of at least 0.941 g/cc (see Encyclopedia of Chemical Technology by Kirk & Othmer, Vol. 17, page 704, 1996). The polyethylene can contain processing aids, stabilizers, antioxidants, antiozonants, pigments, lubricants, flow control agents, and the like in amounts that are normally within the range of about 10 ppm to about 7 parts per 100 parts of polymer. Hindered phenols, such as Irganox® 1010, Irganox® 1076, and Irganox® 1330, are preferred primary antioxidants that can be employed in the polyethylene. Irgafos® 168 and IrganoxPS802 are secondary antioxidants that can be utilized in the polyethylene as thermal processing aids. Carbon black is an example of a black pigment and titanium dioxide is an example of a white pigment that can be used in the polyethylene to attain a desired color.

The silane grafted crosslinkable polyethylene will have vinyl trialkoxysilane units, such as vinyl trimethoxysilane and/or vinyl triethoxysilane, grafted onto the backbone thereof. This is accomplished by first mixing the vinyl triakloxysilane throughout the polyethylene. This mixing step is conducted at a temperature which is above the melting point of the polyethylene to attain a relatively homogeneous mixture. This mixing can be conducted in an extruder, such as a twin screw extruder, and is preferably done under low moisture conditions. For instance, a dry inert gas, such as nitrogen, can be introduced into the extruder to displace moist air.

After the vinyl trialkoxysilane has been dispersed throughout polyethylene, free radicals are generated in the polyethylene composition by exposing it to radiation, such as electron beams, a source of gamma radiation, or ultra-violet light. However, it is normally preferred to incorporate a chemical free radical generator into the polyethylene to ensure a fast and uniform rate of grafting. This can be accomplished by adding the chemical free radical generator to the mixer or extruder used to disperse the vinyl trialkoxysilane into the polyethylene resin. The chemical free radical generator can also be added via a separate feed stream as long as good mixing is attained.

The free radical generator will typically be an alkylperoxide, actylperoxide, ketoneperoxide, hydroperoxide, peroxocarbonate, persters, peroxoketal, peroxooligomer, or azo compound. In most applications it is highly preferred to employ a peroxide that does not generate any toxic species as reaction by-products. In many cases the free radical generator will be an organic alkylperoxide selected from the group consisting of 2,5-dimethyl-2,5-di(tertiary-butylperoxy)hexane, 2,5-dimethyl-2,5-di(tertiary-butylperoxy)3-hexine, di(tertiarybutyl)peroxide, 1,3-di(tertiary-butyl-peroxyiso-propyl)benzol, dicumylperoxide, tertiary-butylcumylperoxide. Such peroxides are typically employed at a level which is within the range of 0.01 weight percent to about 0.12 weight percent, based upon the total weight of the polymeric composition. It is normally preferred for the peroxide to be present at a level which is within the range of 0.02 weight percent to about 0.1 weight percent with a level which is within the range of 0.04 weight percent to about 0.08 weight percent being more typical.

The reaction scheme used to graft the vinyl trimethoxysilane onto the polyethylene can be depicted as follows:

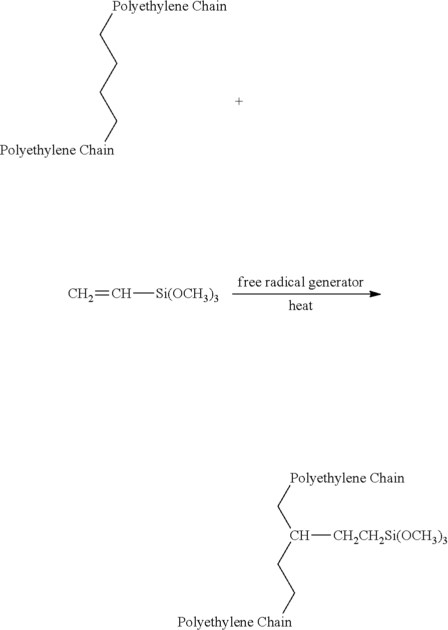

As is illustrated in the reaction scheme shown above, vinyl methoxysilane, CH₂═CHSi(OCH₃)₃, is grafted onto the backbone of the polyethylene in the presence of free radicals at an elevated temperature. In cases where chemical free radical generators are used it is important for the elevated temperature utilized to be high enough to generate free radicals at a reasonable rate. This elevated temperature will be above the decomposition temperature of the chemical free radical generator in cases where a chemical free radical generator is employed. This temperature will normally be above about 150° C. and will often be above about 170° C. As the reaction proceeds vinyl trimethoxysilane units (—CH₂CH₂Si(OCH₃)₃) are grafted onto the backbone of the polyethylene. The distribution of vinyl trimethoxysilane units along the polyethylene backbone is essentially random in order.

The weight of the vinyl trialkoxysilane units in the polyethylene polymer will typically represents from about 0.5 weight percent to about 4 weight percent of the total weight of the polymer. Typically, the weight of the vinyl trialkoxysilane units in the polyethylene polymer will represent from about 1 weight percent to about 3 weight percent of the total weight of the polymer. More typically, the weight of the vinyl trialkoxysilane units in the polyethylene polymer will represent from about 1.5 weight percent to about 2.5 weight percent of the total weight of the polymer.

After the graft polyethylene polymer has been synthesized, it is typically pelletized and stored for later use in moisture free environment. For instance, the resin can be advantageously stored in bags that inhibit moisture penetration, such as foil-lined bags, to protect the crosslinkable graft polyethylene from moisture to prevent premature crosslinking.

The molecular sieve can be distributed into the crosslinkable silane graft polyethylene polymer initially, before the vinyl trialkoxysilane units are grafted onto its backbone. It can be mixed into the polyethylene alone with the vinyl trialkoxysilene utilized as the grafting agent or as a separate component. It can also be mixed into the polyethylene after the silane units have been grafted thereon as a part of the resin manufacturing process prior to pelletization and packaging. The molecular sieve can also optionally be added to the crosslinkable silane graft polyethylene polymer in a subsequent compounding step prior to being molded into the desired article of manufacture. The molecular sieve can be dry blended into the polyethylene at any of these points of addition or it can be added at any of these points as a masterbatch. For instance, the molecular sieve can also be blended into low melt index low density polyethylene, medium density polyethylene and/or high density polyethylene, typically at a level of 2 to 10 weight percent to make a masterbatch, and then dispersed into the polyethylene. In the alternative the molecular sieve can be mixed into mineral spirits, glycerine, propylene glycol, or the like and then dispersed into the polyethylene at any point during the process. Of course, a catalyst/molecular sieve masterbatch will be added during the article fabrication step such as at the point of catalyst addition in a process for making a crosslinked polyethylene pipe.

The molecular sieve will typically have a pore diameter which is within the range of 4.0 Å to about 6.0 Å. It will more typically have a pore diameter which is within the range of 4.5 Å to about 5.5 Å and will preferably have a pore diameter which is within the range of 4.8 Å to about 5.2 Å. The molecular sieve will most preferably have a pore diameter of about 5 Å. The molecular sieve will also have an average particle size of less than about 15 which is preferable less than about 12 μm, and which is most preferable less than 10 μm. The molecular sieve will typically be blended into the polyethylene at a level which is within the range of 0.05 pph (parts per 100 parts by weight of polymer) to about 6 pph. The molecular sieve will more typically be included in the polyethylene at a level which is in the range of 0.1 pph to about 4 pph with levels in the range of 0.1 pph to 1 pph being widely applicable. The molecular sieve will preferably be blended into the polyethylene at a level to attain an crosslinked polyethylene article, such as a pipe, having a concentration of the molecular sieve in the body thereof which is within the range of 0.15 pph to about 0.5 pph and will more typically be blended into the polyethylene at a level which is within the range of 0.15 pph to 0.25 pph. In cases where the molecular sieve is incorporated into a pipe liner, as described in U.S. Pat. No. 7,086,421, it will be added at a high concentration level which is typically within the range of about 4 pph to about 6 pph. A molecular sieve of the chemical formula: (AlO₂)ₓ(SiO₂)_{y} can be utilized wherein x and y represent numerical variables. It is particularly beneficial to utilize a hydrophobic molecular sieve in the practice of this invention.

A catalyst is then typically added to the crosslinkable graft polyethylene, it is then molded or extruded into a desired shape and is then subsequently cured (crosslinked) via conventional techniques. Such techniques are disclosed in U.S. Pat. No. 6,284,178 and U.S. Pat. No. 7,086,421. The teachings of U.S. Pat. No. 6,284,178 and U.S. Pat. No. 7,086,421 are incorporated herein by reference for the purpose of teaching techniques for manufacturing articles which are comprised of crosslinked polyethylene. Generally, in such techniques a catalyst or catalyst masterbatch is blended into the crosslinkable graft polyethylene. This can conveniently be done in a single screw extruder having a L/D which is within the range of 18-32. The catalyst is typically a tin catalyst, such as dibutyltindilaurate, dibutyltinoxide, tinoctoate, dibutyltinmaleate or titanylacetonate. A primary antioxidant, such as a hindered phenol, a secondary antioxidant, a hindered amine light stabilizer, such as Tinuvin® 111, and/or a pigment can optionally also be added to the crosslinkable graft polyethylene during this mixing step.

The crosslinkable graft polyethylene with a catalyst blended therein is then molded or extruded into a desired form, such as that of a pipe or tube. Pipes or tubes made in such a manner can then optionally be reformed. For instance, an enlarged sealing surface may be formed on a tubular product as described in U.S. Pat. No. 5,879,723, the teachings of which are hereby incorporated herein by reference. If such a sealing surface is to be formed on the product, preferably the product is heated to an elevated temperature and then reformed between a pair of mating dies. However, it should be understood that other procedures may be followed for reforming the product without departing from the principles of the present invention.

The formed article is then cured by subjecting it to an elevated temperature and moisture, in the form of liquid water, water vapor or steam. This can be accomplished by heating the formed article to a temperature of at least about 160° F. (71° C.) and preferably at least 180° F. (82° C.). Steam is typically introduced into the vessel wherein the article is cured to ensure that a sufficient quantity of water is present to allow for an efficient cure cycle. The cure reaction involves a hydrolysis step which consumes water and which produces methanol or ethanol depending upon whether the silane unit participating in the reaction is a vinyl trimethyoxysilane unit or a vinyl triethoxysilane unit. This hydrolysis step can be depicted as follows:

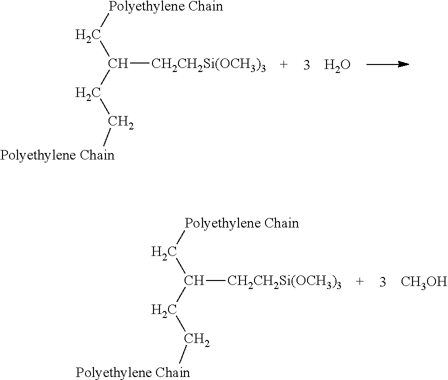

The hydrolysis step is followed by a condensation step which provides a crosslink between polyethylene chains and which produces water. This hydrolysis step between vinyl trimethoxysilane units on adjacent polyethylene chains can be depicted as follows:

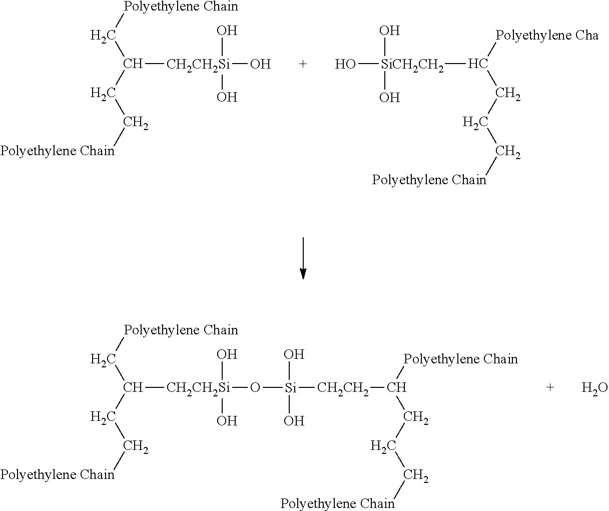

This reaction crosslinks polyethylene chains within the polymer structure which results in increased maximum useful service temperature, reduced creep, improved chemical resistance, increased abrasion resistance, improved memory characteristics, improved impact resistance, and improved environmental stress cracking resistance as compared to uncrosslinked polyethylene. By utilizing the technique of this invention the amount of extractable methanol in articles made therewith can be reduced by 50 percent and in some cases even greater levels.

This invention is illustrated by the following examples that are merely for the purpose of illustration and are not to be regarded as limiting the scope of the invention or the manner in which it can be practiced. Unless specifically indicated otherwise, parts and percentages are given by weight.

### Examples 1-2

In this series of experiments Sclair® high density polyethylene was crosslinked with vinyl trimethoxysilane utilizing conventional technology. Molecular sieves were blended into the polyethylene samples and these samples were also crosslinked. The molecular sieve was added to the polyethylene used in making the pipe liner at a level of 5 weight percent or was added to the polyethylene utilized in making a total pipe body at a level of 0.2 weight percent. In both cases the same total amount of the molecular sieve was added with it naturally being much more concentrated in the case where it was only added to the pipe liner. Both of the molecular sieves have a pore size of 5 Å with one of the molecular sieves being hydrophobic. The extractable methanol level in each of the cured samples as compared to the control was then determined by NSF-61 testing. The result of this testing is reported in Table 1.

| | Extractable Methanol Level | | |
|---|---|---|---|
| | Without | | Hydrophobic |
| | Molecular | Molecular | Molecular |
| | Sieve | Sieve 5 Å | Sieve 5 Å * |
| In Pipe Liner ** | 100% | 100% | 53% |
| In Pipe Body | 100% | 60% | 43% |

* Abscents ™ 3000 Deodorizing Powder from UOP LLC, Des Plaines, IL 60017-5017. This molecular sieve is a hydrophobic powder that is reported to be highly effective for adsorbing straight chain and low molecular weight organics, including aliphatics, alcohols, aldehydes, ketones, amines, esters, olefins, mercaptans, chlorinated hydrocarbons, organic acids, and aromatics. This hydrophobic molecular sieve is a white powder and is also reported to be thermally stable up to a temperature of 800° C., to have a particle size of less than 10 μm, and a Hunter color of greater than 94 L.
** The molecular sieve was distributed into a pipe liner as described in U.S. Pat. No. 7,086,421, the teachings of which are incorporated herein by reference for the purpose of describing suitable pipes having liners.

This series of experiments shows that a molecular sieve can be used to reduce the level of extractable methanol in crosslinked polyethylene by more than 50%. This experiment also shows that a better result is attained by dispersing the molecular sieve uniformly throughout the body of the pipe rather than concentrating it in a pipe liner. These experiments also show that there was no benefit in the case where a non-hydrophobic molecular sieve was dispersed throughout a pipe liner. However, in the case where a hydrophobic molecular sieve was distributed throughout the pipe liner a significant reduction in the level of extractable methanol was realized. The utilization of the hydrophobic molecular sieve resulted in a significant reduction in the level of extractable methanol in cases where it was concentrated in the pipe liner and where it was distributed uniformly throughout the total body of the pipe. It should be noted that this technology can be implemented without compromising polymer properties, cure cycle times or manufacturing costs.

While certain representative embodiments and details have been shown for the purpose of illustrating the subject invention, it will be apparent to those skilled in this art that various changes and modifications can be made therein without departing from the scope of the subject invention.

What is claimed is:

1. A crosslinkable polyethylene graft polymer composition which is comprised of polyethylene and a hydrophobic molecular sieve, wherein the polyethylene has vinyl trialkoxysilane units grafted thereon, and wherein the molecular sieve has a pore diameter which is within the range of 4.0 Å to about 6.0 Å, and wherein the molecular sieve has an average particle size of less than about 15 μm.

2. The crosslinkable polyethylene graft polymer specified in claim 1 wherein the vinyl trialkoxysilane is vinyl trimethoxysilane.

3. The crosslinkable polyethylene graft polymer specified in claim 2 wherein the molecular sieve has a pore size which is within the range of 4.5 Å to about 5.5 Å.

4. The crosslinkable polyethylene graft polymer specified in claim 3 wherein the molecular sieve has an average particle size of less than about 12 μm.

5. The crosslinkable polyethylene graft polymer specified in claim 4 wherein the molecular sieve is present at a level which is within the range of 0.05 parts to 6 parts per 100 parts of polyethylene by weight.

6. The crosslinkable polyethylene graft polymer specified in claim 2 wherein the molecular sieve has a pore size which is within the range of 4.8 Å to about 5.2 Å.

7. The crosslinkable polyethylene graft polymer specified in claim 6 wherein the hydrophobic molecular sieve has an average particle size of less than about 10 μm.

8. The crosslinkable polyethylene graft polymer specified in claim 7 wherein the molecular sieve is present at a level which is within the range of 0.1 parts to 1 parts per 100 parts of polyethylene by weight.

9. The crosslinkable polyethylene graft polymer specified in claim 7 wherein the molecular sieve is present at a level which is within the range of 0.15 parts to 0.5 parts per 100 parts of polyethylene by weight.

10. The crosslinkable polyethylene graft polymer specified in claim 9 wherein the molecular sieve has a pore size of about 5.0 Å.

11. The crosslinkable polyethylene graft polymer specified in claim 2 wherein the weight of the vinyl trimethoxysilane units in the polymer represents from about 0.5 weight percent to about 4 weight percent of the total weight of the polymer.

12. The crosslinkable polyethylene graft polymer specified in claim 2 wherein the weight of the vinyl trimethoxysilane units in the polymer represents from about 1 weight percent to about 3 weight percent of the total weight of the polymer.

13. The crosslinkable polyethylene graft polymer specified in claim 2 wherein the molecular sieve is a hydrophobic molecular sieve.

14. The crosslinkable polyethylene graft polymer specified in claim 2 wherein the weight of the vinyl trimethoxysilane units in the polymer represents from about 1.5 weight percent to about 2.5 weight percent of the total weight of the polymer.

15. The crosslinkable polyethylene composition as specified in claim 1 which is further comprised of a tin catalyst.

16. The crosslinkable polyethylene composition as specified in claim 1 wherein the polyethylene has a density of at least about 0.941 g/cc.

17. A process for manufacturing polyethylene pipe which comprises (1) extruding a crosslinkable polyethylene graft polymer composition into a the form of an uncured pipe, wherein the crosslinkable polyethylene graft polymer composition is comprised of polyethylene and a hydrophobic molecular sieve, wherein the polyethylene has vinyl trialkoxysilane units grafted thereon, and wherein the molecular sieve has a pore diameter which is within the range of 4.0 Å to about 6.0 Å, and wherein the molecular sieve has an average particle size of less than about 15 μm, (2) curing uncured pipe at an elevated temperature of at least about 150° F. in the presence of moisture to produce a cured pipe, and (3) allowing the cured pipe to cool to ambient temperature to produce the polyethylene pipe.

18. A process for manufacturing polyethylene pipe as specified in claim 17 wherein the crosslinkable polyethylene composition is further comprised of a tin catalyst and wherein the polyethylene has a density of at least about 0.941 g/cc, and wherein the molecular sieve is a hydrophobic molecular sieve.

19. A process for manufacturing polyethylene pipe as specified in claim 17 wherein the wherein the vinyl trialkoxysilane is vinyl trimethoxysilane, 2 wherein the hydrophobic molecular sieve has a pore size which is within the range of 4.5 Å to about 5.5 Å, wherein the hydrophobic molecular sieve has an average particle size of less than about 12 μm, and wherein the hydrophobic molecular sieve is present at a level which is within the range of 0.05 parts to 6 parts per 100 parts of polyethylene by weight.

20. A crosslinked polyethylene pipe wherein the body of the pipe is comprised of a crosslinked polyethylene graft polymer which includes a hydrophobic molecular sieve having a pore diameter which is within the range of 4.0 Å to about 6.0 Å, wherein the molecular sieve is present in the body of the pipe at a level which is within the range of 0.05 parts to 4 parts per 100 parts of crosslinked polyethylene by weight, and wherein the molecular sieve has an average particle size of less than about 15 μm.
